(19) United States
(12) Patent Application Publication
(10) Pub. No.: US 2024/0185722 A1
(43) Pub. Date: Jun. 6, 2024

(54) Methods for Detecting Vulnerable Road Users by Way of a Vehicle

(71) Applicant: Bayerische Motoren Werke Aktiengesellschaft, München (DE)

(72) Inventors: Sonila DOBI, Muenchen (DE); Almir MEHMEDOVIC, Neufahrn (DE)

(21) Appl. No.: 18/285,888

(22) PCT Filed: Apr. 5, 2022
(86) PCT No.: PCT/EP2022/058998

§ 371 Date: Oct. 6, 2023

(30) Foreign Application Priority Data
Apr. 8, 2021 (DE) 10 2021 108 807.0

(51) Int. Cl. G08G 1/16; G06T 7/20; G06T 7/70; G06V 20/56; G06V 20/58

(52) U.S. Cl. CPC G08G 1/167; G06T 7/20; G06T 7/70; G06V 20/58; G06V 20/588; G08G 1/166; G06T 2207/30256; G06T 2207/30261

(57) ABSTRACT

A method for detecting vulnerable road users by using a vehicle includes ascertaining a current lane in which the vehicle is moving, a left-hand lane that is located to the left next to the current lane and/or a right-hand lane that is located to the right next to the current lane. The method also includes defining a virtual left-hand side lane that is located to the left next to the left-hand lane and/or a virtual right-hand side lane that is located to the right next to the right-hand lane, and comparing an ascertained position of a vulnerable road user with the virtual left-hand side lane and/or the virtual right-hand side lane. The method also includes tracking the ascertained position of the vulnerable road user when the comparison reveals that the position of the vulnerable road user is in the virtual left-hand side lane and/or in the virtual right-hand side lane.

### BACKGROUND AND SUMMARY OF THE INVENTION

The present invention relates to methods for detecting vulnerable road users by way of a vehicle, to a control unit and to a vehicle. The present invention lies in the field of automotive engineering.

A conventional, automated vehicle is unable to detect or identify vulnerable road users (VRUs), such as pedestrians, cyclists and motorcyclists, for example, in certain surrounding areas of the vehicle. Safety measures are therefore necessary to prevent possible collisions with them.

More specifically, even in the case of conventional vehicles, it is possible, using image data provided by a camera installed on the outside of the vehicle, to detect VRUs within lanes that are likewise detected by way of these image data, such as in a left-hand and a right-hand lane, the automated vehicle being in a middle lane, with a sufficiently high degree of reliability.

If the road being driven on has three lanes (left-hand, middle, right-hand), for example, there are also areas outside of these lanes, such as entry and/or exit lanes, shoulders and/or a physical lane divider which separates the running traffic from oncoming traffic (typically on a freeway). All VRUs in the lanes (left-hand, middle, right-hand), in the entry and/or exit lanes, on the shoulders and also on the side of the lane divider where the running traffic is located ought to be taken into account and trigger a high-priority warning signal to the driver that there is a high risk of a collision with a VRU. For the normal lanes identified by the camera, the list of the VRUs is assigned to each lane in accordance with the relative position of the VRUs and the distance to the left-hand and right-hand lane marking for each lane.

However, it is problematic that conventional systems are unable to detect, or are unable to detect with a sufficient degree of reliability, the VRUs in a region or an area which is outside of the detected lanes but is nevertheless an area into which the vehicle can drive or into which the vehicle can move.

Against the background of this prior art, the object of the present invention is to specify methods, a control unit and a vehicle which are suitable for overcoming at least the above-mentioned disadvantages of the prior art.

The object is achieved by the features of the claimed invention.

The object is accordingly achieved by a method for detecting vulnerable road users by way of a vehicle, which method comprises ascertaining a current lane in which the vehicle is moving, a left-hand lane which is located to the left next to the current lane, and/or a right-hand lane which is located to the right next to the current lane. In this case, the method is characterized in that it further comprises defining a virtual left-hand side lane which is located to the left next to the left-hand lane and/or a virtual right-hand side lane which is located to the right next to the right-hand lane. In addition, the method comprises comparing an ascertained position of a vulnerable road user with the virtual left-hand side lane and/or the virtual right-hand side lane, and tracking the ascertained position of the vulnerable road user if the comparison reveals that the position of the vulnerable road user is in the virtual left-hand side lane and/or in the virtual right-hand side lane.

In addition, the object is achieved by a method for detecting vulnerable road users by way of a vehicle, which method comprises ascertaining a current lane in which the vehicle is moving, a left-hand lane which is located to the left next to the current lane, and/or a right-hand lane which is located to the right next to the current lane. In this case, the method is characterized in that it further comprises determining a left-hand safety area which is located to the left next to the left-hand lane and/or a right-hand safety area which is located to the right next to the right-hand lane, and comparing an ascertained position of a vulnerable road user with the left-hand safety area and/or the right-hand safety area, and tracking the ascertained position of the vulnerable road user if the comparison reveals that the position of the vulnerable road user is in the left-hand and/or right-hand safety area.

In addition, the object is achieved by a method for detecting vulnerable road users by way of a vehicle, which method comprises ascertaining a current lane in which the vehicle is moving, a left-hand lane which is located to the left next to the current lane, and/or a right-hand lane which is located to the right next to the current lane. In this case, the method is characterized in that it comprises determining a distance from an ascertained position of a vulnerable road user to the left-hand edge of the left-hand lane and/or to the right-hand edge of the right-hand lane, and tracking the ascertained position of the vulnerable road user if the determined distance is less than a predefined threshold value.

In the case of a two-lane road, the current lane can be a right-hand or left-hand lane. In the case of a three-lane road, the current lane can be a right-hand, middle or left-hand lane.

Moreover, the object is achieved by a control unit which is characterized in that it is configured to perform a method according to embodiments of the invention.

Furthermore, the object is achieved by a vehicle which is characterized in that it comprises at least one camera, at least one radar sensor and a control unit according to embodiments of the invention.

A vulnerable road user can be a moving object which is moving or can move relative to the vehicle and the movements of which are trackable. For instance, a vulnerable road user can be a pedestrian, a cyclist, a motorcyclist and/or a playing child. A vulnerable road user can also be an animal, such as a dog, for instance. A vulnerable road user is in particular a moving object which is participating or can participate in road traffic and which can cause a risk of collision with the vehicle.

In this case, the middle lane is that lane in which the vehicle is moving. The left-hand and right-hand lane are those lanes which are located to the left and right, respectively, next to the middle lane. In this case, it is not necessarily required for each of the lanes to be formed by an actual lane. Rather, in this case, a corresponding virtual assignment of a spatial area which is optionally located ahead of the vehicle in the driving direction of the vehicle may be involved in a computer-aided driver assistance system and/or in the computer-aided automated driving system.

In this case, the virtual left-hand side lane and/or the virtual right-hand side lane can constitute a virtual extension of the lanes which do not necessarily have to have an equivalent in an associated lane. Rather, in this case, a virtual instrument which is used to extend the area to be monitored for detecting vulnerable road users may be involved. The virtual left-hand side lane and/or the virtual right-hand side lane can, however, be oriented to match the ascertained lanes in terms of their course and extend these ascertained lanes on the left-hand and right-hand side, respectively.

In this case, the left-hand and/or right-hand safety area are areas which are virtually defined, wherein vulnerable road users and moving objects in general which are in one of the safety areas are attributed a possible risk of collision. In particular, the safety areas can be determined in such a way that a concrete risk of collision results from a possible movement of a vulnerable road user in one of the safety areas and due to the left-hand, middle or right-hand lane potentially being entered and/or driven on as a result.

Determining the distance from an ascertained position of a vulnerable road user to the left-hand edge of the left-hand lane and/or to the right-hand edge of the right-hand lane can comprise calculating an actual physical distance from the position of the vulnerable road user to the nearest point of the left-hand lane and/or to the right-hand edge of the right-hand lane.

Tracking the ascertained position in this case constitutes repeated and optionally regular updating of the ascertained position and taking into account the updated position in the detection of vulnerable road users. In other words, tracking the ascertained position enables optionally continuous detection of the respective vulnerable road user such that a possible risk of the vehicle colliding with the vulnerable road user can also then be reliably ascertained if the vulnerable road user moves and the risk of collision potentially needs to be reassessed.

The invention offers the advantage of it being possible to detect even those vulnerable road users who are not directly in the middle, left-hand or right-hand lane but who nevertheless can cause a risk of collision, in particular due to a possible movement of the respective vulnerable road user themselves. Moreover, the invention offers the advantage that the detection of vulnerable road users who are in an area outside of the middle, left-hand or right-hand lane can be implemented with little computing complexity and optionally without the need for hardware that is not already available. The invention therefore offers the advantage that the detection of a risk of collision can be improved and the safety of the vehicle for the occupants and other road users can accordingly be yet further increased.

Optionally, the virtual left-hand side lane extends with a predetermined width between a left-hand edge of the left-hand lane and a left-hand road boundary and runs parallel to the left-hand lane. As an alternative or in addition, the virtual right-hand side lane extends with a predetermined width between a right-hand edge of the right-hand lane and a right-hand road boundary and runs parallel to the right-hand lane. In this case, the road boundary can be a border at which the road that is able to be driven on ends. In this case, the road boundary can in particular constitute a virtual border or a virtual position or a virtual course in the internal calculation of a control unit. Optionally, the road boundary can be determined on the basis of image data from a camera and/or on the basis of radar sensor data. Optionally, detected immovable obstacles, such as, for instance, buildings, structural barriers, such as, for instance, crash barriers and/or vegetation, such as, for instance, trees and/or bushes, can be detected and the position thereof can be used for determining the road boundary. Optionally, the course of the lanes in combination with detected obstacles can also be used for determining the road boundary. Extending by a left-hand and/or right-hand lane offers the advantage that it allows simple implementation which can take place, for example, analogous to the ascertainment of the left-hand, middle and right-hand lane.

Optionally, the left-hand safety area extends with a predetermined width between a left-hand edge of the left-hand lane and a left-hand road boundary. As an alternative or in addition, the right-hand safety area optionally extends with a predetermined width between a right-hand edge of the right-hand lane and a right-hand road boundary. This offers the advantage that the left-hand or right-hand safety area can run parallel to the course of the respectively adjoining edge of the right-hand or left-hand lane or parallel to the respective road boundary. As a result, particularly simple implementation can take place. The predetermined width can for example be chosen depending on the expected speed at which the vulnerable road users can possibly move in the direction of the lanes.

Optionally, the distance constitutes a physical distance from the ascertained position of the vulnerable road user to the left-hand edge of the left-hand lane or to the right-hand edge of the right-hand lane. In other words, the actual distance taken up between the vulnerable road user and the edge of the left-hand or right-hand lane can optionally be calculated. In this way, a possible risk of collision can be ascertained particularly accurately.

Optionally, the left-hand, current and/or right-hand lane are/is ascertained on the basis of image data captured by at least one camera. For example, ascertaining the lanes can comprise identifying the lane in the image data. Optionally, the road boundary is ascertained on the basis of radar sensor data. This offers the possibility of detecting, in a particularly reliable manner, potential obstacles which border the road and of ascertaining the distance to the road boundary in a particularly reliable manner.

A vehicle can in particular be designed as a motor vehicle, such as, for instance, as a passenger car, truck or motorcycle. The vehicle can optionally be designed as a vehicle which is able to be driven in a partially or completely automated manner.

One embodiment is described below with reference to FIG. 1.

### BRIEF DESCRIPTION OF THE DRAWING

FIG. 1 schematically shows a flowchart of a method for detecting vulnerable road users by way of a vehicle according to a preferred embodiment.

### DETAILED DESCRIPTION OF THE DRAWING

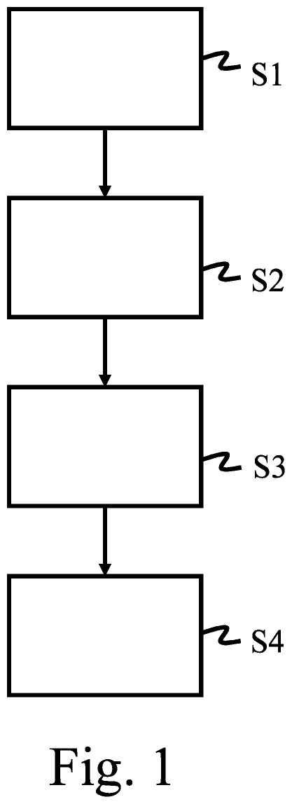

FIG. 1 shows a schematic flowchart of a method for detecting vulnerable road users by way of a vehicle according to an optional embodiment. In this case, the method comprises a first method step S1 in which a current lane, here a middle lane, in which the vehicle is moving, a left-hand lane which is located to the left next to the middle lane, and a right-hand lane which is located to the right next to the middle lane are ascertained. The method further comprises a second method step S2 in which a virtual left-hand side lane which is located to the left next to the left-hand lane and/or a virtual right-hand side lane which is located to the right next to the right-hand lane are/is defined. In addition, the method comprises a third method step S3 in which an ascertained position of a vulnerable road user is compared with the virtual left-hand side lane and/or the virtual right-hand side lane. Moreover, the method comprises a fourth method step S4 in which the ascertained position of the vulnerable road user is tracked if the comparison reveals that the position of the vulnerable road user is in the virtual left-hand side lane and/or in the virtual right-hand side lane. If the comparison reveals that the position of the vulnerable road user is outside of the left-hand side lane and outside of the right-hand side lane and also outside of the lanes, the ascertained position of the vulnerable road user is not tracked according to this optional embodiment since the risk of collision is low and/or the vulnerable road user is classified as uncritical for the driving course, for instance.

According to the explained optional embodiment, the virtual left-hand side lane extends with a predetermined width between a left-hand edge of the left-hand lane and a left-hand road boundary and runs parallel to the left-hand lane. Likewise, the virtual right-hand side lane can extend with a predetermined width between a right-hand edge of the right-hand lane and a right-hand road boundary and run parallel to the right-hand lane.

According to another optional embodiment, the method steps S2 to S4 can be designed differently from those of the first embodiment explained above. In this case, the method step S2 can comprise determining a left-hand safety area which is located to the left next to the left-hand lane and/or a right-hand safety area which is located to the right next to the right-hand lane. Method step S3 can comprise comparing an ascertained position of a vulnerable road user with the left-hand safety area and/or the right-hand safety area, and the method step S4 can comprise tracking the ascertained position of the vulnerable road user if the comparison reveals that the position of the vulnerable road user is in the left-hand and/or right-hand safety area.

According to this second optional embodiment, the left-hand safety area can extend with a predetermined width between a left-hand edge of the left-hand lane and a left-hand road boundary. Likewise, the right-hand safety area can extend with a predetermined width between a right-hand edge of the right-hand lane and a right-hand road boundary.

According to a third optional embodiment, the method steps S2 to S4 can differ from those method steps S2 to S4 explained above. In this case, the method steps S2 and S3 can be combined and comprise or consist in determining a distance from an ascertained position of a vulnerable road user to the left-hand edge of the left-hand lane and/or to the right-hand edge of the right-hand lane. The method step S4 can comprise tracking the ascertained position of the vulnerable road user if the determined distance is less than a predefined threshold value.

According to this third optional embodiment, the distance can constitute a physical distance from the ascertained position of the vulnerable road user to the left-hand edge of the left-hand lane or to the right-hand edge of the right-hand lane.

In some optional embodiments, the left-hand, middle and right-hand lane can be ascertained on the basis of image data captured by at least one camera. For example, this can be done by applying automated image evaluation to the image data provided by the camera. In contrast, the road boundary can be ascertained on the basis of radar sensor data, for example. According to some optional embodiments, the method for detecting vulnerable road users can thus use both image data from a camera and radar sensor data from a radar sensor, on the basis of which vulnerable road users away from the lanes are detected and on the basis of which the relevance of the detected vulnerable road users can be assessed with regard to a possible risk of collision.

### LIST OF REFERENCE SIGNS

S1 first method step
S2 second method step
S3 third method step
S4 fourth method step

1.-10. (canceled)

11. A method for detecting vulnerable road users by way of a vehicle, the method comprising:
ascertaining a current lane in which the vehicle is moving, a left-hand lane which is located to the left next to the current lane, and/or a right-hand lane which is located to the right next to the current lane;
defining a virtual left-hand side lane which is located to the left next to the left-hand lane, and/or a virtual right-hand side lane which is located to the right next to the right-hand lane;
comparing an ascertained position of a vulnerable road user with the virtual left-hand side lane and/or the virtual right-hand side lane; and
tracking the ascertained position of the vulnerable road user upon determining that the ascertained position of the vulnerable road user is in the virtual left-hand side lane and/or in the virtual right-hand side lane.

12. The method according to claim 11, wherein:
the virtual left-hand side lane extends with a predetermined width between a left-hand edge of the left-hand lane and a left-hand road boundary and runs parallel to the left-hand lane, and/or
the virtual right-hand lane side extends with a predetermined width between a right-hand edge of the right-hand lane and a right-hand road boundary and runs parallel to the right-hand lane.

13. A method for detecting vulnerable road users by way of a vehicle, the method comprising:
ascertaining a current lane in which the vehicle is moving, a left-hand lane which is located to the left next to the current lane, and/or a right-hand lane which is located to the right next to the current lane;
determining a left-hand safety area which is located to the left next to the left-hand lane, and/or a right-hand safety area which is located to the right next to the right-hand lane;
comparing an ascertained position of a vulnerable road user with the left-hand safety area and/or the right-hand safety area; and
tracking the ascertained position of the vulnerable road user upon determining that the ascertained position of the vulnerable road user is in the left-hand safety area and/or the right-hand safety area.

14. The method according to claim 13, wherein:
the left-hand safety area extends with a predetermined width between a left-hand edge of the left-hand lane and a left-hand road boundary, and/or
the right-hand safety area extends with a predetermined width between a right-hand edge of the right-hand lane and a right-hand road boundary.

15. A method for detecting vulnerable road users by way of a vehicle, the method comprising:
ascertaining a current lane in which the vehicle is moving, a left-hand lane which is located to the left next to the current lane, and/or a right-hand lane which is located to the right next to the current lane;
determining a distance from an ascertained position of a vulnerable road user to the left-hand edge of the left-hand lane and/or to the right-hand edge of the right-hand lane; and
tracking the ascertained position of the vulnerable road user upon determining that the distance is less than a predefined threshold value.

16. The method according to claim 15, wherein the distance constitutes a physical distance from the ascertained position of the vulnerable road user to the left-hand edge of the left-hand lane or to the right-hand edge of the right-hand lane.

17. The method according to claim 11, wherein the left-hand lane, the current lane and/or the right-hand lane is ascertained based on image data captured by at least one camera.

18. The method according to claim 11, wherein a road boundary is ascertained based on radar sensor data.

19. A control unit that is configured to perform the method according to claim 11.

20. A vehicle comprising:
at least one camera,
at least one radar sensor, and
the control unit according to claim 19.
